(19) United States
(12) Patent Application Publication
(10) Pub. No.: US 2025/0193677 A1
(43) Pub. Date: Jun. 12, 2025

(54) SYSTEMS AND METHODS FOR FILTERING OF MALICIOUS RADIO FREQUENCY-BASED DATA

(71) Applicant: CenturyLink Intellectual Property LLC, Denver, CO (US)

(72) Inventors: Dean Ballew, Sterling, VA (US); John R.B. Woodworth, Amissville, VA (US)

(73) Assignee: CenturyLink Intellectual Property LLC, Denver, CO (US)

(21) Appl. No.: 18/971,913

(22) Filed: Dec. 6, 2024

Related U.S. Application Data
(60) Provisional application No. 63/609,016, filed on Dec. 12, 2023.

(51) Int. Cl. H04W 12/128

(52) U.S. Cl. CPC H04W 12/128

(57) ABSTRACT

The present application describes systems and methods for filtering of malicious radio frequency (RF)-based data. A computing device includes a baseband filter configured to filter RF-based data. The baseband filter is configured to inspect information provided by the baseband processor before providing the information to other portions of the computing device, such as an application processor. In some examples, the baseband filter inspects a command and an operand in received RF-based data to determine the validity of the command and the operand. In some examples, if the RF-based data includes a read command to read a portion of memory, the baseband filter determines if the portion of memory is allowed to be read by (provided to) the baseband processor.

### CROSS-REFERENCE TO RELATED APPLICATIONS

This application claims the benefit of U.S. Provisional Application No. 63/609,016 filed Dec. 12, 2023, entitled “Systems and Methods for Filtering of Malicious Radio Frequency-Based Data,” which is incorporated herein by reference in its entirety.

### BACKGROUND

A baseband processor manages the radio functions of a computing device. The baseband processor coverts radio frequency (RF) signals into digital data, and vice versa. The baseband processor is a chip or a part of a chip on a computing device such as a smartphone, tablet, or any other computing device that has radio capabilities.

### SUMMARY

The present application describes systems and methods for filtering of malicious radio frequency (RF)-based data.

In an aspect, the present application relates to a baseband filtering system comprising: a baseband processor; an application processor; and a baseband filter coupled to the baseband processor, the baseband filter comprising: at least one processor; and a memory operatively connected to the processor and storing instructions that, when executed by the processor, cause the system to perform a method, the method comprising: receiving RF-based data from the baseband processor; identifying a command and an operand in the RF-based data; determining that the command is valid when the command is identified in a restricted set of commands; determining that the command is invalid when the command is not identified in the restricted set of commands; determining that the operand is valid when a size of the operand is within an allowed operand size range; determining that the operand is invalid when the size of the operand is outside of the allowed operand size range; and providing the RF-based data to the application processor when the command is valid and the operand is valid.

In some examples, the method further comprises: receiving second RF-based data from the baseband processor; identifying, in the second RF-based data, a read command to read information from a portion of a second memory; determining whether the portion of the second memory is associated with a baseband flag; determining whether the read command is allowed based at least in part on determining whether the portion of the second memory is associated with the baseband flag; and providing the second RF data to the application processor when the read command is allowed.

In some examples, the allowed operand size range is identified in one or more allowed operand size range sand is based at least in part on an operand type.

In some examples, the baseband filter is implemented on a same chip as a memory management unit (MMU).

In some examples, the baseband filter is implemented on a same chip as the application processor.

In some examples, the command is a write command.

In another aspect, the present application relates to a baseband filtering system comprising: at least one processor; and a memory operatively connected to the processor and storing instructions that, when executed by the processor, cause the system to perform a method, the method comprising: receiving RF-based data from a baseband processor; identifying a command and an operand in the RF-based data; determining that the command is valid when the command is identified in a restricted set of commands; determining that the command is invalid when the command is not identified in the restricted set of commands; determining that the operand is valid when a size of the operand is within an allowed operand size range; determining that the operand is invalid when the size of the operand is outside of the allowed operand size range; and executing the command when the command is valid and the operand is valid.

In some examples, the method further comprises: receiving second RF-based data from the baseband processor; identifying, in the second RF-based data, a read command to read information from a portion of a second memory; determining whether the portion of the second memory is associated with a baseband flag; determining whether the read command is allowed based at least in part on determining whether the portion of the second memory is associated with the baseband flag; and providing the second RF data to an application processor when the read command is allowed.

In some examples, the allowed operand size range is identified in one or more allowed operand size ranges and is based at least in part on an operand type.

In some examples, a baseband filter of the baseband filtering system is implemented on a same chip as an MMU.

In some examples, a baseband filter of the baseband filtering system is implemented on a same chip as the application processor.

In some examples, the command is a write command, and wherein executing the command comprises writing the operand to a second memory, and wherein the second memory comprises a shared memory or storage.

In yet another aspect, the present application relates to a method, comprising: receiving RF-based data from a baseband processor; identifying, in the RF-based data, a read command to read information from a portion of a memory; determining whether the portion of the memory is associated with a baseband flag; determining whether the read command is allowed based at least in part on determining whether the portion of the memory is associated with the baseband flag; and providing the RF-based data to an application processor when the read command is allowed.

In some examples, the method further comprises: receiving second RF-based data from the baseband processor; identifying a command and an operand in the second RF-based data; determining that the command is valid when the command is identified in a restricted set of commands; determining that the command is invalid when the command is not identified in the restricted set of commands; determining that the operand is valid when a size of the operand is within an allowed operand size range; determining that the operand is invalid when the size of the operand is outside of the allowed operand size range; and providing the second RF data to the application processor when the command is valid and the operand is valid.

In some examples, the command is a write command.

In some examples, the method further comprises: providing one or more random bits to the baseband processor when the read command is not allowed.

In some examples, the method further comprises: receiving, from the application processor, a mapping indicating portions of the memory that are associated with the baseband flag.

In some examples, determining whether the read command is allowed based at least in part on determining whether the portion of the memory is associated with the baseband flag comprises: determining that the read command is allowed based at least in part on the portion of the memory being associated with the baseband flag.

In some examples, when the read command is allowed, the method further comprises: receiving the information from the memory or the application processor; and providing the information to the baseband processor.

In some examples, the baseband flag comprises a baseband flag bit or a baseband flag header.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 is a block diagram depicting an example system according to aspects of the present application.

FIG. 2 is a block diagram depicting an example system according to aspects of the present application.

FIG. 3 is a block diagram depicting an example system according to aspects of the present application.

FIG. 4 is a flowchart depicting an example method according to aspects of the present application.

FIG. 5 is a flowchart depicting an example method according to aspects of the present application.

FIG. 6 is a block diagram depicting an example computing environment in which systems and methods of the present application may be implemented.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems or devices. Accordingly, examples may take the form of a hardware implementation, an entirely software implementation, or an implementation combining software and hardware aspects. In addition, all systems described with respect to the Figures can comprise one or more machines or devices that are operatively connected to cooperate in order to provide the described system functionality. The following detailed description is therefore not to be taken in a limiting sense, and the scope of the present disclosure is defined by the appended claims and their equivalents.

A baseband processor manages the radio functions of a computing device of a user. The baseband processor is a chip or a part of a chip on a computing device such as a smartphone, tablet, or any other computing device that has radio capabilities. For example, the baseband processor coverts radio frequency (RF) signals into digital data, and vice versa. However, the computing device may receive malicious RF signals from malicious third party devices. The baseband processor converts the malicious RF signals into malicious digital data (e.g., malicious RF-based data) and provides the malicious digital data to other portions of the computing device (e.g., an application processor), which may compromise the computing device. A solution for filtering RF-based data is desirable.

In accordance with aspects of the present disclosure, systems and methods for filtering of malicious RF-based data are described. A baseband filter is configured to receive RF-based data from a baseband processor and inspect the RF-based data before providing the RF-based data to other portions of the computing device, such as an application processor or a shared memory. In some examples, if the baseband filter identifies a command in the RF-based data, the baseband filter inspects the command and a corresponding operand to determine if the command and the corresponding operand are valid. In some examples, if the baseband filter identifies a read command in the RF-based data, the baseband filter determines whether a portion of shared memory or storage that the read command is attempting to read from is allowed to be read by (provided to) the baseband processor. For example, the baseband filter may identify whether a baseband flag is associated with the portion of the shared memory or storage that the read command is attempting to read from, which may indicate whether the portion is allowed to be read by (provided to) the baseband processor.

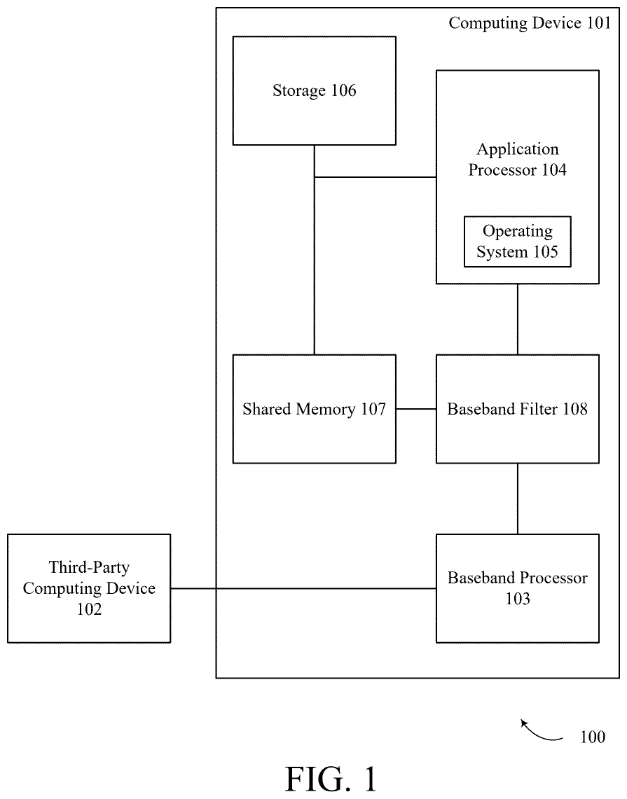

FIG. 1 discloses an example system 100 that implements systems and methods for filtering of malicious RF-based data according to aspects of the present disclosure. System 100, as presented, includes a combination of interdependent components that interact to form an integrated whole. Components of system 100 include hardware components or software components implemented on and/or executed by hardware components of system 100. In some examples, components of system 100 are distributed across multiple processing devices or computing systems.

System 100 includes computing device 101, third-party computing device 102, baseband processor 103, application processor 104, operating system (OS) 105, storage 106, shared memory 107, and baseband filter 108. Computing device 101 includes baseband processor 103, application processor 104, storage 106, shared memory 107, and baseband filter 108. Application processor 104 includes OS 105. Application processor 104, baseband processor 103, and baseband filter 108 may be on separate chips, or may be on a same chip, or any combination of these components on same or different chips. The scale and structure of devices and environments discussed herein may vary and may include additional or fewer components than those described in FIG. 1 and subsequent figures.

Computing device 101 represents a computer (e.g., a personal computer (“PC”), a laptop, a server), a mobile device (e.g., smartphone or a tablet), or any other type of electronic processing device. Computing device 101 may be capable of receiving and processing RF signals. For example, computing device may receive RF signaling from third-party computing device 102.

Third-party computing device 102 represents a computer (e.g., a personal computer (“PC”), a laptop, a server), a mobile device (e.g., smartphone or a tablet), a cell tower, or any other type of electronic device (e.g., electronic device capable of transmitting RF signals). In some cases, third-party computing device 102 may be a malicious device configured to transmit (e.g., broadcast) malicious RF signals. Computing device 101 may receive the transmitted RF signals from third-party computing device 102.

Baseband processor 103 manages the radio functions of computing device 101. Baseband processor 103 coverts RF signals into digital data, and vice versa. For example, when computing device 101 receives RF signals from third-party computing device 102, baseband processor 103 converts the received RF signals into digital data (referred to herein as RF-based data). Baseband processor 103 provides the RF-based data to baseband filter 108, as will be discussed herein.

Application processor 104 is a processing component on computing device 101. In some examples, application processor 104 may include a central processing unit (CPU). Application processor 104 may be designed for mobile devices (e.g., smartphones, tablets, wearable devices). Application processor 104 performs tasks including running OS 105, applications, user interfaces, multimedia, communication functions, or a combination of these. Application processor 104 may read from, or write to, storage 106, shared memory 107, or both.

OS 105 is a type of software that manages one or more functions of computing device 101 (e.g., executing programs, controlling devices or components, allocating resources). In examples, OS 105 may provide a mapping to baseband filter 108 indicating portions of storage 106, shared memory 107, or both, that are associated with a baseband flag or are not associated with a baseband flag, as will be discussed herein.

Storage 106 includes non-volatile memory (e.g., a hard disk drive (HDD), a solid state drive (SSD), a secure digital (SD) card, a flash drive, a floppy disk, a compact disk, read-only memory (ROM), or the like). Storage 106 may store application instructions and/or data upon which such instructions operate. Storage 106 may provide data to application processor 104 (e.g., during a read operation), or receive data from application processor 104 (e.g., during a write operation). In some examples, storage 106 may provide data to shared memory 107 or receive data from shared memory 107, or both (e.g., storage 106, shared memory 107, or both, may have direct memory access (DMA) functionality).

Shared memory 107 includes volatile memory (e.g., random access memory (RAM)) that is shared between baseband filter 108 and application processor 104. Prevailing technologies typically have a shared memory being shared between a baseband processor and an application processor, while the present disclosure offers enhanced security by implementing baseband filter 108 between baseband processor 103 and application processor 104. Accordingly, shared memory 107 may be operatively connected to baseband filter 108 and application processor 104. In some examples, baseband processor 103 may not have direct access to shared memory 107.

Baseband filter 108 is software, hardware, firmware, or a combination of these, that filters RF-based data. In some examples, baseband filter 108 may act like a proxy for baseband processor 103, or may serve as a firewall between baseband processor 103 and application processor 104. Third-party computing device 102 may transmit RF signals to computing device 101. Baseband processor 103 may convert the transmitted RF signals to RF-based data. Baseband processor 103 provides the RF-based data to baseband filter 108.

Baseband filter 108 may filter the RF-based data. For example, baseband filter 108 may identify a command and an operand in the RF-based data. The command may be a command to be executed by computing device 101. The operand may include data on which the command is to be performed. For example, the command may be a write command, and the operand may include an IP address, and may indicate that the IP address is to be written to shared memory 107, storage 106, or both, of computing device 101. Baseband filter 108 may store or otherwise have access to a restricted set of commands (e.g., a table, or any data structure), indicating which commands from baseband processor 103 are allowed to be performed by computing device 101. Additionally or alternatively, baseband filter 108 may store or otherwise have access to a set of disallowed commands (e.g., a table, or any data structure), indicating which commands from baseband processor 103 are not allowed to be performed by computing device 101. Baseband filter 108 determines that the command is valid when the command is identified in the restricted set of commands or when the command is not identified in the set of disallowed commands. Baseband filter 108 determines that the command is not valid when the command is not identified in the restricted set of commands or when the command is identified in the set of disallowed commands.

Baseband filter 108 may also store or otherwise have access to one or more allowed operand size ranges (e.g., operand size thresholds) or other allowed operand parameters. In examples, different operands (e.g., operand types) may correspond to different allowed operand size ranges. Baseband filter 108 may store or otherwise have access to a map (e.g., a table, or any data structure) mapping operand types to corresponding allowed operand size ranges. Additionally or alternatively, baseband filter 108 may store or otherwise have access to one or more disallowed operand size ranges (e.g., disallowed operand size thresholds). Different operands (e.g., operand types) may correspond to different disallowed operand size ranges. Baseband filter 108 may store or otherwise have access to a map (e.g., a table, or any data structure) mapping operand types to corresponding disallowed operand size ranges. Baseband filter 108 determines that the operand is valid when the operand is within an allowed operand size range for the operand type or when the operand is not within a disallowed operand size range for the operand type. Baseband filter 108 determines that the operand is invalid when the operand is outside of the allowed operand size range for the operand type or when the operand is within the disallowed operand size range for the operand type. If both the command and operand are valid, baseband filter 108 may provide the RF-based data to application processor 104 for command execution, or may execute the command itself. For example, if the command is a write command to write an operand to storage 106 or shared memory 107, application processor 104 may receive the command from baseband filter 108 and may write the operand to storage 106 or shared memory 107. Alternatively, baseband filter 108 may write the operand to shared memory 107 or storage 106 (e.g., by writing to shared memory 107, which is then transferred to storage 106, for example, by application processor 104).

In some examples, baseband filter 108 may identify, in the RF-based data, a read command to read information from a portion of memory (e.g., a portion of shared memory 107, storage 106, or both) of computing device 101. Baseband filter 108 may determine that the read command is allowed if the portion of the memory (e.g., the portion of shared memory 107, storage 106, or both) is associated with a baseband flag, where the baseband flag indicates that the portion of the memory (e.g., the portion of shared memory 107, storage 106, or both) is allowed to be read by (provided to) baseband processor 103. Alternatively, baseband filter 108 may determine that the read command is allowed if the portion of the memory (e.g., the portion of shared memory 107, storage 106, or both) is not associated with a baseband flag, where the baseband flag indicates that the portion of the memory (e.g., the portion of shared memory 107, storage 106, or both) is not allowed to be read by (provided to) baseband processor 103. In some other examples, baseband filter 108 may determine that the read command is disallowed if the portion of the memory (e.g., the portion of shared memory 107, storage 106, or both) is associated with a baseband flag, where the baseband flag indicates that the portion of the memory (e.g., the portion of shared memory 107, storage 106, or both) is disallowed to be read by (provided to) baseband processor 103. Alternatively, baseband filter 108 may determine that the read command is disallowed if the portion of the memory (e.g., the portion of shared memory 107, storage 106, or both) is not associated with a baseband flag, where the baseband flag indicates that the portion of the memory (e.g., the portion of shared memory 107, storage 106, or both) is allowed to be read by (provided to) baseband processor 103. If the read command is allowed, baseband filter 108 provides the RF-based data to application processor 104 for command execution, or may execute the read command itself. For example, if the read command is to read from storage 106 or shared memory 107, application processor 104 may receive the read command from baseband filter 108, may read from storage 106 or shared memory 107, and may provide the read data to baseband filter 108. Alternatively, baseband filter 108 may read from shared memory 107 or storage 106 (e.g., by requesting application processor 104 to read from storage 106 and provide the read data to shared memory 107 to be read by baseband filter 108). Baseband filter 108 then provides the read data to baseband processor 103. Baseband processor 103 may convert the read data into RF signals for transmission by computing device 101 (e.g., to third-party computing device 102). If the read command is disallowed, baseband filter 108 may provide random data (e.g., one or more random bits) to baseband processor 103, or may do nothing. In such cases, baseband processor 103 may convert the random data into RF signals for transmission by computing device 101 (e.g., to third-party computing device 102).

The baseband flag may include a baseband flag bit, a baseband flag header, or the like. For example, storage 106, shared memory 107, or both, may include portions that store flag bits, indicating that corresponding portions of storage 106, shared memory 107, or both, are allowed to be read by (provided to) baseband processor 103. OS 105 resets baseband flags when the associated portion of shared memory 107 or storage 106 is read and provided to baseband processor 103 (e.g., indicating that the portion may not be read again until the baseband flag is updated by OS 105). For example, a flag bit for a portion of shared memory 107 may be present (e.g., logic state 1) to indicate that the portion is allowed to be read by (provided to) baseband processor 103. When the portion of shared memory 107 is read and provided to baseband processor 103, OS 105 may change the logic state of the flag bit from logic state 1 to logic state 0, preventing repeated reads of the portion of shared memory 107. OS 105 may separately and independently (e.g., at a later time) determine that the portion is again allowed to be read by (provided to) baseband processor 103, and may change the logic state of the flag bit from logic state 0 back to logic state 1.

As described previously, OS 105 may provide a mapping to baseband filter 108 indicating portions of storage 106, shared memory 107, or both, that are associated with a baseband flag, not associated with a baseband flag, or both. Baseband filter 108 may be able to quickly determine whether a read command from baseband processor 103 is allowed to execute to access the requested portion of storage 106, shared memory 107, or both, using the mapping.

In some examples, baseband filter 108 may be able to directly read and/or write to shared memory 107, storage 106, or both, with one or more similar capabilities as application processor 104. For example, baseband filter 108 may have DMA functionality. For example, after filtering the RF-based data as previously described, baseband filter 108 may read from, write to, or both, shared memory 107 or storage 106, rather than providing the RF-based data to application processor 104 for command execution.

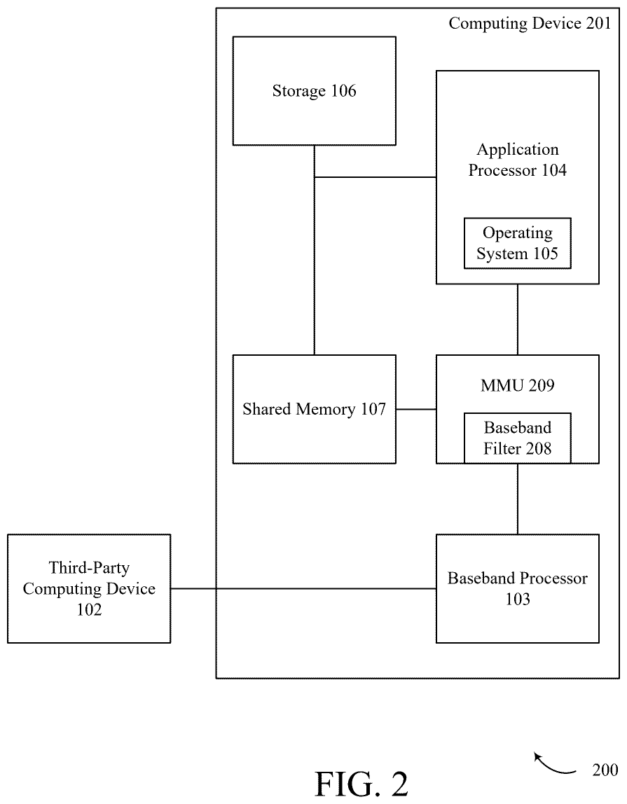

FIG. 2 discloses an example system 200 that implements systems and methods for filtering of malicious RF-based data according to aspects of the present disclosure. System 200, as presented, includes a combination of interdependent components that interact to form an integrated whole. Components of system 200 include hardware components or software components implemented on and/or executed by hardware components of system 200. In some examples, components of system 200 are distributed across multiple processing devices or computing systems. Repeated discussion of similar aspects is omitted for brevity.

System 200 includes computing device 201, third-party computing device 102, baseband processor 103, application processor 104, operating system 105, storage 106, shared memory 107, baseband filter 208, and memory management unit (MMU) 209. Computing device 201 and baseband filter 208 may include one or more similar aspects as computing device 101 and baseband filter 108, respectively. Computing device 101 includes baseband processor 103, application processor 104, storage 106, shared memory 107, and MMU 209. Application processor 104 includes OS 105. MMU 209 includes baseband filter 208 (e.g., may be on a same chip). MMU 209 is a computer hardware unit that translates virtual addresses to a physical addresses. Application processor 104, baseband processor 103, and MMU 209 may be on separate chips, a same chip, or any combination of these components on same or different chips. The scale and structure of devices and environments discussed herein may vary and may include additional or fewer components than those described in FIG. 2 and subsequent figures.

Baseband processor 103 is configured to provide RF-based data to baseband filter 208. Baseband filter 208 may be implemented on MMU 209. In some examples, baseband filter 208 may function similarly as baseband filter 108, but implemented on MMU 209. In some examples, baseband filter 208 may be software, firmware, hardware, or a combination of these, implemented on MMU 209 configured to perform one or more functions previously described regarding baseband filter 108. In some examples, MMU 209 may include one or more similar functionalities with respect to baseband filter 108. In some examples, MMU 209, baseband filter 208, or any combination, may be configured to communicate with shared memory 107, storage 106, application processor 104, baseband processor 103, or any combination.

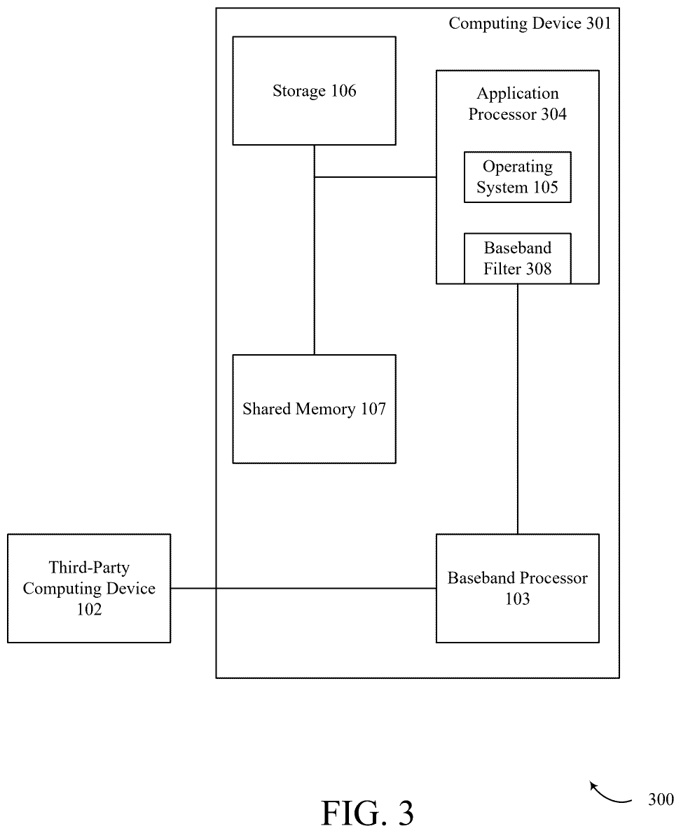

FIG. 3 discloses an example system 300 that implements systems and methods for filtering of malicious RF-based data according to aspects of the present disclosure. System 300, as presented, includes a combination of interdependent components that interact to form an integrated whole. Components of system 300 include hardware components or software components implemented on and/or executed by hardware components of system 300. In some examples, components of system 300 are distributed across multiple processing devices or computing systems. Repeated discussion of similar aspects is omitted for brevity.

System 300 includes computing device 301, third-party computing device 102, baseband processor 103, application processor 304, operating system 105, storage 106, shared memory 107, and baseband filter 308. Computing device 301, application processor 304, and baseband filter 308 may include one or more similar aspects as computing device 201 and/or 101, application processor 104, and baseband filter 108 and/or 208, respectively. Computing device 101 includes baseband processor 103, application processor 304, storage 106, and shared memory 107. Application processor 304 includes OS 105, and baseband filter 308 (e.g., baseband filter 308 and application processor may be on a same chip). Application processor 304 and baseband processor 103 may be on separate chips, a same chip, or any combination of these components on same or different chips. The scale and structure of devices and environments discussed herein may vary and may include additional or fewer components than those described in FIG. 3 and subsequent figures.

Baseband processor 103 is configured to provide RF-based data to baseband filter 308. Baseband filter 308 may be implemented on application processor 304. In some examples, baseband filter 308 may function similarly as baseband filter 108 and/or 208, but implemented on application processor 304. In some examples, baseband filter 308 may be software, firmware, hardware, or a combination of these, implemented on application processor 304 configured to perform one or more functions previously described regarding baseband filter 108 and/or 208. In some examples, application processor 304 may include one or more similar functionalities with respect to baseband filter 108 and/or 208. In some examples, application processor 304, baseband filter 308, or any combination, may be configured to communicate with shared memory 107, storage 106, baseband processor 103, or any combination.

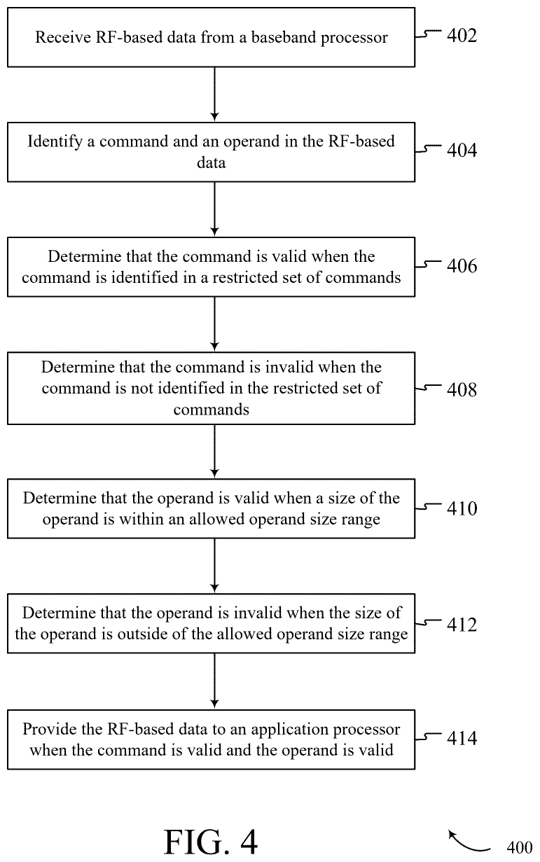

FIG. 4 illustrates an example method 400 in accordance with the present application. In some examples, some or all of the operations of method 400 are performed by computing device 101, computing device 201, computing device 301, baseband filter 108, baseband filter 208, baseband filter 308, or any combination of these. In some examples, baseband filter 108, 208, or 308 is implemented on a same chip as an MMU. In some examples, baseband filter 108, 208, or 308 is implemented on a same chip as application processor 104 or 304.

At operation 402, method 400 may include receiving RF-based data (e.g., data based on RF signaling received by computing device 101) from the baseband processor (e.g., baseband processor 103).

At operation 404, method 400 may include identifying a command and an operand in the RF-based data. In some examples, the command is a write command.

At operation 406, method 400 may include determining that the command is valid when the command is identified in a restricted set of commands.

At operation 408, method 400 may include determining that the command is invalid when the command is not identified in the restricted set of commands.

At operation 410, method 400 may include determining that the operand is valid when a size of the operand is within an allowed operand size range. In some examples, the allowed operand size range is identified in one or more allowed operand size range sand is based at least in part on an operand type.

At operation 412, method 400 may include determining that the operand is invalid when the size of the operand is outside of the allowed operand size range.

At operation 414, method 400 may include providing the RF-based data to an application processor (e.g., application processor 104, 304) when the command is valid and the operand is valid.

In some examples, method 400 may further comprise: receiving second RF-based data from the baseband processor; identifying, in the second RF-based data, a read command to read information from a portion of a second memory (e.g., shared memory 107, storage 106); determining whether the portion of the second memory is associated with a baseband flag; determining whether the read command is allowed based at least in part on determining whether the portion of the second memory is associated with the baseband flag; and providing the second RF data to the application processor when the read command is allowed.

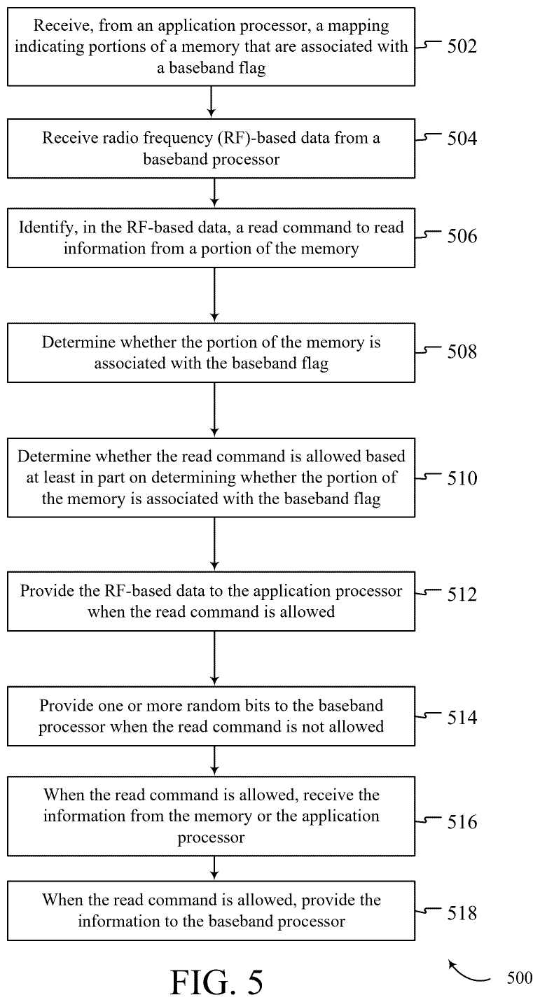

FIG. 5 illustrates an example method 500 in accordance with the present application. In some examples, some or all of the operations of method 500 are performed by computing device 101, computing device 201, computing device 301, baseband filter 108, baseband filter 208, baseband filter 308, or a combination of these.

At operation 502, method 500 may include receiving, from an application processor (e.g., application processor 104, 304), a mapping indicating portions of a memory (e.g., shared memory 107, storage 106) that are associated with a baseband flag. The baseband flag may indicate portions of memory that are allowed or disallowed to be read by (provided to) baseband processor 103.

At operation 504, method 500 may include receiving radio frequency (RF)-based data (e.g., data based on RF signaling received by computing device 101) from a baseband processor (e.g., baseband processor 103).

At operation 506, method 500 may include identifying, in the RF-based data, a read command to read information from a portion of the memory.

At operation 508, method 500 may include determining whether the portion of the memory is associated with the baseband flag.

At operation 510, method 500 may include determining whether the read command is allowed based at least in part on determining whether the portion of the memory is associated with the baseband flag.

At operation 512, method 500 may include providing the RF-based data to the application processor when the read command is allowed.

At operation 514, method 500 may include providing one or more random bits to the baseband processor when the read command is not allowed.

At operation 516, when the read command is allowed, method 500 may include receiving the information from the memory or the application processor.

At operation 518, when the read command is allowed, method 500 may include providing the information to the baseband processor.

In some examples, method 500 may further comprise: receiving second RF-based data from the baseband processor; identifying a command and an operand in the second RF-based data; determining that the command is valid when the command is identified in a restricted set of commands; determining that the command is invalid when the command is not identified in the restricted set of commands; determining that the operand is valid when a size of the operand is within an allowed operand size range; determining that the operand is invalid when the size of the operand is outside of the allowed operand size range; and providing the second RF data to the application processor when the command is valid and the operand is valid. In some examples, the command is a write command.

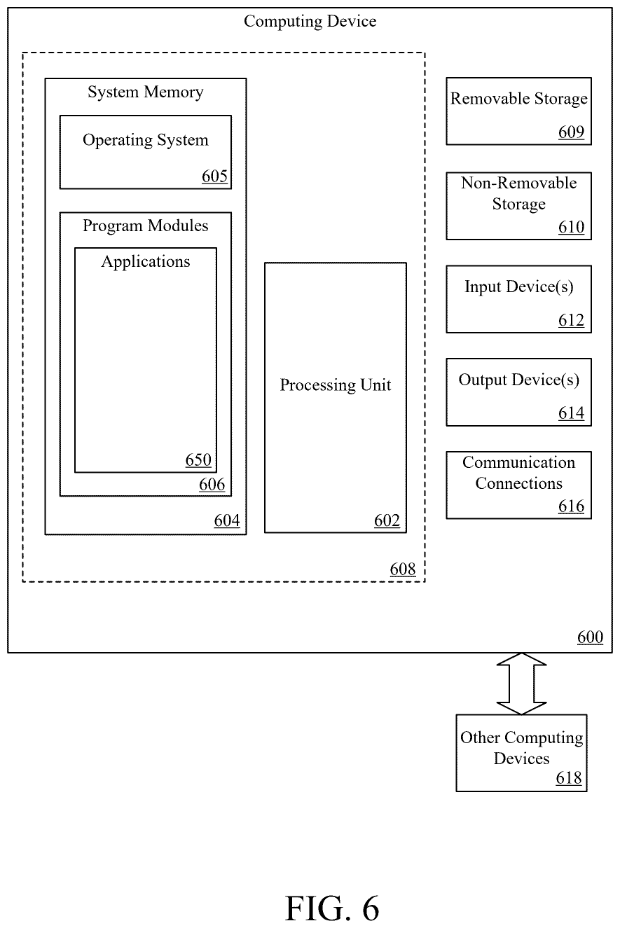

FIG. 6 is a block diagram illustrating physical components (i.e., hardware) of a computing device 600 with which examples of the present disclosure may be practiced. The computing device components described below may be suitable for a customer device implanting one or more of devices included in computing device 101, computing device 201, computing device 301, baseband filter 108, baseband filter 208, baseband filter 308, or other components of FIGS. 1-3. In a basic configuration, the computing device 600 may include at least one processing unit 602 and a system memory 604. The processing unit(s) (e.g., processors) may be referred to as a processing system. Depending on the configuration and type of computing device, the system memory 604 may comprise, but is not limited to, volatile storage (e.g., random access memory), non-volatile storage (e.g., read-only memory), flash memory, or any combination of such memories. The system memory 604 may include an operating system 605 and one or more program modules 606 suitable for running software applications 650 to implement one or more of the systems described above with respect to FIGS. 1-2.

The operating system 605, for example, may be suitable for controlling the operation of the computing device 600. Furthermore, aspects of the invention may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 609 and a non-removable storage device 610.

As stated above, a number of program modules and data files may be stored in the system memory 604. While executing on the processing unit 602, the program modules 606 may perform processes including, but not limited to, one or more of the operations illustrated in FIGS. 3-4. Other program modules that may be used in accordance with examples of the present invention and may include applications such as electronic mail and contacts applications, word processing applications, spreadsheet applications, database applications, slide presentation applications, drawing or computer-aided application programs, etc.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to generating suggested queries, may be operated via application-specific logic integrated with other components of the computing device 600 on the single integrated circuit (chip). Examples of the present disclosure may also be practiced using other technologies capable of performing logical operations such as, for example, AND, OR, and NOT, including but not limited to mechanical, optical, fluidic, and quantum technologies.

The computing device 600 may also have one or more input device(s) 612 such as a keyboard, a mouse, a pen, a sound input device, a touch input device, etc. The output device(s) 614 such as a display, speakers, a printer, etc. may also be included. The aforementioned devices are examples and others may be used. The computing device 600 may include one or more communication connections 616 allowing communications with other computing devices 618. Examples of suitable communication connections 616 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (i.e., memory storage.) Computer storage media may include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600. Computer storage media may be non-transitory and tangible and does not include a carrier wave or other propagated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, RF, infrared, and other wireless media.

Aspects of the present invention, for example, are described above with reference to block diagrams and/or operational illustrations of methods, systems, and computer program products according to aspects of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved. Further, as used herein and in the claims, the phrase “at least one of element A, element B, or element C” is intended to convey any of: element A, element B, element C, elements A and B, elements A and C, elements B and C, and elements A, B, and C.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A baseband filtering system comprising:
a baseband processor;
an application processor; and
a baseband filter coupled to the baseband processor, the baseband filter comprising:
at least one processor; and
a memory operatively connected to the processor and storing instructions that, when executed by the processor, cause the system to perform a method, the method comprising:
receiving RF-based data from the baseband processor;
identifying a command and an operand in the RF-based data;
determining that the command is valid when the command is identified in a restricted set of commands;
determining that the command is invalid when the command is not identified in the restricted set of commands;
determining that the operand is valid when a size of the operand is within an allowed operand size range;
determining that the operand is invalid when the size of the operand is outside of the allowed operand size range; and
providing the RF-based data to the application processor when the command is valid and the operand is valid.

2. The baseband filtering system of claim 1, the method further comprising:
receiving second RF-based data from the baseband processor;
identifying, in the second RF-based data, a read command to read information from a portion of a second memory;
determining whether the portion of the second memory is associated with a baseband flag;
determining whether the read command is allowed based at least in part on determining whether the portion of the second memory is associated with the baseband flag; and
providing the second RF data to the application processor when the read command is allowed.

3. The baseband filtering system of claim 1, wherein the allowed operand size range is identified in one or more allowed operand size range sand is based at least in part on an operand type.

4. The baseband filtering system of claim 1, wherein the baseband filter is implemented on a same chip as a memory management unit (MMU).

5. The baseband filtering system of claim 1, wherein the baseband filter is implemented on a same chip as the application processor.

6. The baseband filtering system of claim 1, wherein the command is a write command.

7. A baseband filtering system comprising:
at least one processor; and
a memory operatively connected to the processor and storing instructions that, when executed by the processor, cause the system to perform a method, the method comprising:
receiving radio frequency (RF)-based data from a baseband processor;
identifying a command and an operand in the RF-based data;
determining that the command is valid when the command is identified in a restricted set of commands;
determining that the command is invalid when the command is not identified in the restricted set of commands;
determining that the operand is valid when a size of the operand is within an allowed operand size range;
determining that the operand is invalid when the size of the operand is outside of the allowed operand size range; and
executing the command when the command is valid and the operand is valid.

8. The baseband filtering system of claim 7, the method further comprising:
receiving second RF-based data from the baseband processor;
identifying, in the second RF-based data, a read command to read information from a portion of a second memory;
determining whether the portion of the second memory is associated with a baseband flag;
determining whether the read command is allowed based at least in part on determining whether the portion of the second memory is associated with the baseband flag; and
providing the second RF data to an application processor when the read command is allowed.

9. The baseband filtering system of claim 7, wherein the allowed operand size range is identified in one or more allowed operand size ranges and is based at least in part on an operand type.

10. The baseband filtering system of claim 7, wherein a baseband filter of the baseband filtering system is implemented on a same chip as a memory management unit (MMU).

11. The baseband filtering system of claim 7, wherein a baseband filter of the baseband filtering system is implemented on a same chip as the application processor.

12. The baseband filtering system of claim 7, wherein the command is a write command, and wherein executing the command comprises writing the operand to a second memory, and wherein the second memory comprises a shared memory or storage.

13. A method, comprising:
receiving radio frequency (RF)-based data from a baseband processor;
identifying, in the RF-based data, a read command to read information from a portion of a memory;
determining whether the portion of the memory is associated with a baseband flag;
determining whether the read command is allowed based at least in part on determining whether the portion of the memory is associated with the baseband flag; and
providing the RF-based data to an application processor when the read command is allowed.

14. The method of claim 13, further comprising:
receiving second RF-based data from the baseband processor;
identifying a command and an operand in the second RF-based data;
determining that the command is valid when the command is identified in a restricted set of commands;
determining that the command is invalid when the command is not identified in the restricted set of commands;
determining that the operand is valid when a size of the operand is within an allowed operand size range;
determining that the operand is invalid when the size of the operand is outside of the allowed operand size range; and
providing the second RF data to the application processor when the command is valid and the operand is valid.

15. The method of claim 14, wherein the command is a write command.

16. The method of claim 13, further comprising:
providing one or more random bits to the baseband processor when the read command is not allowed.

17. The method of claim 13, further comprising:
receiving, from the application processor, a mapping indicating portions of the memory that are associated with the baseband flag.

18. The method of claim 13, wherein determining whether the read command is allowed based at least in part on determining whether the portion of the memory is associated with the baseband flag comprises:
determining that the read command is allowed based at least in part on the portion of the memory being associated with the baseband flag.

19. The method of claim 13, wherein when the read command is allowed, the method further comprises:
receiving the information from the memory or the application processor; and
providing the information to the baseband processor.

20. The method of claim 13, wherein the baseband flag comprises a baseband flag bit or a baseband flag header.
